(19) United States
(12) Patent Application Publication
(10) Pub. No.: US 2025/0387886 A1
(43) Pub. Date: Dec. 25, 2025

(54) IMPACT WRENCH AND POWER TOOL

(71) Applicant: Nanjing Chervon Industry Co., Ltd., Nanjing (CN)

(72) Inventors: Guangjie Ji, Nanjing (CN); Hongtao Ke, Nanjing (CN)

(21) Appl. No.: 19/223,350

(22) Filed: May 30, 2025

(30) Foreign Application Priority Data
Jun. 25, 2024 (CN) 202410833328.5
Jun. 25, 2024 (CN) 202410833539.9
Jun. 25, 2024 (CN) 202410834170.3
Jun. 25, 2024 (CN) 202410838148.6
Jun. 25, 2024 (CN) 202410838177.2

(51) Int. Cl. B25B 21/02; B25F 5/00; B25F 5/02

(52) U.S. Cl. CPC B25B 21/02; B25F 5/001; B25F 5/02

(57) ABSTRACT

An impact wrench includes a housing, an electric motor, an anvil, a grip, an impact assembly, and a transmission assembly, where the transmission assembly is disposed between the electric motor and the impact assembly. The transmission assembly includes a main shaft disposed in the extension direction of the rotor shaft and including multiple planetary shafts, where multiple planet gears are disposed around the multiple planetary shafts, respectively, and a gear extends into the main shaft and drives the multiple planet gears; and a rear cover surrounding at least part of the main shaft from the rear to the front, where the rear cover is formed with an inner ring gear, and the inner ring gear meshes with the multiple planet gears. When the multiple planet gears rotate in the inner ring gear, the rear cover is in sliding contact with the main shaft.

### RELATED APPLICATION INFORMATION

This application claims the benefit under 35 U.S.C. § 119(a) of Chinese Patent Application No. CN 202410834170.3, filed on Jun. 25, 2024, Chinese Patent Application No. CN 202410838177.2 filed on Jun. 25, 2024, Chinese Patent Application No. CN 202410833328.5 filed on Jun. 25, 2024, Chinese Patent Application No. CN 202410833539.9 filed on Jun. 25, 2024, and Chinese Patent Application No. CN 202410838148.6 filed on Jun. 25, 2024, which applications are incorporated herein by reference in their entireties.

### TECHNICAL FIELD

The present application relates to the technical field of power tools and, in particular, to an impact wrench and a power tool.

### BACKGROUND

The power tool is more environmentally friendly than the engine tool and is therefore widely used. Generally, the electric motor drives the power tool to work. An impact tool refers to a power tool capable of outputting the rotational motion at a certain impact frequency. Common impact tools include an impact wrench generally used for screwing bolts, nuts, and the like.

The working condition of the impact wrench is gradually becoming more sophisticated, and the user often requires the impact wrench to be compact and easy to control so that the impact wrench can work well in a relatively narrow space.

This part provides background information related to the present application, and the background information is not necessarily the existing art.

### SUMMARY

An impact wrench includes a housing; an electric motor accommodated in the housing and including a stator assembly and a rotor assembly, where the rotor assembly includes a rotor shaft, and the rotor shaft drives a gear disposed at a front end of the rotor shaft; an anvil for mounting a tool head to output power externally; a grip connected to or formed on the housing; an impact assembly disposed in the housing and used for providing an impact force to the anvil; and a transmission assembly disposed in the housing and used for transmitting the power outputted by the rotor shaft to the impact assembly, where the transmission assembly is disposed between the electric motor and the impact assembly. The transmission assembly includes a main shaft disposed in the extension direction of the rotor shaft and including multiple planetary shafts, where multiple planet gears are disposed around the multiple planetary shafts, respectively, and the gear extends into the main shaft and drives the multiple planet gears; and a rear cover surrounding at least part of the main shaft from the rear to the front, where the rear cover is formed with an inner ring gear, and the inner ring gear meshes with the multiple planet gears. When the multiple planet gears rotate in the inner ring gear, the rear cover is in sliding contact with the main shaft.

In some examples, the rear cover and the inner ring gear are integrally formed.

In some examples, the axial overlap length of a contact region between the rear cover and the main shaft is greater than or equal to 1.5 mm.

In some examples, the outer diameter of the gear is greater than the diameter of the rotor shaft.

In some examples, the electric motor is an inner rotor motor.

In some examples, the impact wrench further includes a front bearing, where the axial positions of the front bearing, the stator assembly, the rear cover, and the main shaft at least partially overlap.

In some examples, the impact wrench has no bearing for the main shaft.

In some examples, the material hardness of a contact region of the rear cover is greater than or equal to 20 HRC.

In some examples, the rear cover is made through powder metallurgy.

In some examples, a contact region of the rear cover is carburized.

In some examples, the impact assembly includes an impact block driven by the electric motor, where the impact block is configured to reciprocate along an axial direction and impact the anvil along a rotational direction, the ratio of the axial movement distance of the impact block to the diameter of the impact block is less than or equal to 0.3, and the distance between the rearmost edge of the housing and the frontmost edge of the anvil is less than or equal to 95 mm.

In some examples, the impact assembly includes an impact block driven by the electric motor, the ratio of the distance between the rearmost edge of the housing and the frontmost edge of the anvil to the diameter of the impact block is less than or equal to 2.5, and the distance between the rearmost edge of the housing and the frontmost edge of the anvil is less than or equal to 95 mm.

In some examples, the impact assembly includes an impact block driven by the electric motor, the ratio of the distance between the rearmost edge of the housing and the frontmost edge of the anvil to the front-to-rear length of the impact block is less than or equal to 4.7, and the distance between the rearmost edge of the housing and the frontmost edge of the anvil is less than or equal to 95 mm.

In some examples, the impact wrench includes a chuck bushing, the anvil includes an anvil bushing, and the axial positions of the chuck bushing and the anvil bushing at least partially overlap.

In some examples, the impact wrench includes a gear button and a battery pack, where the gear button is used for controlling a working gear of the impact wrench, and the gear button is disposed on a side of the battery pack.

In some examples, a power tool includes a housing; an electric motor accommodated in the housing and including a stator assembly and a rotor assembly, where the rotor assembly includes a rotor shaft, and the rotor shaft drives a gear disposed at a front end of the rotor shaft; and a transmission assembly. The transmission assembly includes a main shaft disposed in the extension direction of the rotor shaft and including multiple planetary shafts, where multiple planet gears are disposed around the multiple planetary shafts, respectively, and the gear extends into the main shaft and drives the multiple planet gears; and a rear cover surrounding at least part of the main shaft from the rear to the front, where the rear cover is formed with an inner ring gear, and the inner ring gear meshes with the multiple planet gears. When the multiple planet gears rotate in the inner ring gear, the rear cover is in sliding contact with the main shaft, and the material hardness of a contact region of the rear cover is greater than or equal to 20 HRC.

In some examples, a power tool includes a housing; an electric motor accommodated in the housing and including a stator assembly and a rotor assembly, where the stator assembly includes stator windings and a stator core, the stator windings are wound onto the stator core, the stator core is disposed on the outer circumference of the rotor assembly, the rotor assembly includes a rotor core and a rotor shaft protruding from the end surfaces of the rotor core in the front and rear direction, and the rotor shaft is supported by a front bearing and a rear bearing and drives a gear disposed at a front end of the rotor shaft; and a transmission assembly.

The transmission assembly includes a main shaft disposed in the extension direction of the rotor shaft and including multiple planetary shafts, where multiple planet gears are disposed around the multiple planetary shafts, respectively, and the gear extends into the main shaft and drives the multiple planet gears; and a support portion disposed on the rear part of the main shaft and used for supporting the main shaft.

The axial positions of the support portion, the stator assembly, and the front bearing at least partially overlap, and the outer diameter of the front bearing is greater than or equal to 8 mm and less than or equal to 16 mm.

In some examples, the support portion is a rear cover of a gearbox, the rear cover of the gearbox is formed with an inner ring gear, and the inner ring gear meshes with the multiple planet gears.

In some examples, when the multiple planet gears rotate in the inner ring gear, the rear cover of the gearbox is in sliding contact with the main shaft.

In some examples, the outer diameter of the front bearing is less than or equal to 1.5 times the outer diameter of the rear bearing.

In some examples, a power tool includes a housing; an electric motor accommodated in the housing and including a stator assembly and a rotor assembly, where the stator assembly includes stator windings and a stator core, the stator windings are wound onto the stator core, the rotor assembly includes a rotor shaft, and the rotor shaft drives a gear disposed at a front end of the rotor shaft; an output portion used for mounting a tool head and driven by the gear to output power externally; and a grip connected to or formed on the housing. A bearing is disposed behind the gear and used for supporting the rotor shaft, the inner diameter of the bearing is less than the outer diameter of the gear, and the distance between the bearing and the gear is less than or equal to 12 mm.

In some examples, the rotor shaft and the gear are integrally formed.

In some examples, the bearing is sleeved on the rotor shaft.

In some examples, the rotor shaft includes an axial recessed portion, the gear includes an axial extension portion, and the axial extension portion is inserted into the axial recessed portion.

In some examples, the bearing is sleeved on the axial extension portion.

In some examples, the inner diameter of the bearing is less than or equal to 7 mm.

In some examples, the diameter of the gear is greater than or equal to 7 mm.

In some examples, a power tool includes a housing; an electric motor accommodated in the housing and including a stator assembly and a rotor assembly, where the stator assembly includes stator windings and a stator core, the stator windings are wound onto the stator core, the rotor assembly includes a rotor core and a rotor shaft protruding from the end surfaces of the rotor core in the front and rear direction, the rotor shaft includes a protruding portion and a gear, and the gear is located at a front end of the rotor shaft and is integrally formed with the rotor shaft; an output portion used for mounting a tool head and driven by the gear to output power externally; and a grip connected to or formed on the housing. A front bearing is mounted on the rotor shaft, the front bearing and the gear are disposed behind and in front of the protruding portion, respectively, and the distance between the front bearing and the protruding portion and the distance between the protruding portion and the gear are both less than or equal to 8.5 mm.

In some examples, the diameter of the gear is greater than the diameter of the rotor shaft and less than the diameter of the protruding portion.

In some examples, the stator core is disposed on the outer circumference of the rotor assembly.

In some examples, the axial positions of the front bearing and the stator assembly at least partially overlap.

In some examples, the power tool is an impact wrench.

In some examples, the output portion is an anvil, and the power tool further includes an impact assembly disposed in the housing and used for providing an impact force to the anvil; and a transmission assembly disposed in the housing and used for transmitting the power outputted by the rotor shaft to the impact assembly, where the transmission assembly is disposed between the electric motor and the impact assembly.

In some examples, the rear housing of the gearbox and the inner ring gear of the transmission assembly are integrally formed.

In some examples, the power tool further includes a main shaft, and the axial positions of the main shaft and the stator assembly at least partially overlap.

In some examples, a method for assembling an electric motor of a power tool is provided. The electric motor includes a stator assembly and a rotor assembly, the stator assembly includes stator windings and a stator core, the stator windings are wound onto the stator core, the rotor assembly includes a rotor core and a rotor shaft, the rotor shaft includes a protruding portion and a gear, and the gear is located at a front end of the rotor shaft and is integrally formed with the rotor shaft. A method for assembling the rotor assembly includes sleeving a front bearing on the rotor shaft from a rear end of the rotor shaft; moving the front bearing forward until the front bearing is limited by the protruding portion; and sleeving the rotor core, a fan, and a rear bearing on the rotor shaft in sequence from the rear end of the rotor shaft.

In some examples, an impact wrench includes a housing; an electric motor accommodated in the housing and including a stator assembly and a rotor assembly, where the stator assembly includes stator windings and a stator core, the stator windings are wound onto the stator core, the rotor assembly includes a rotor shaft, and the rotor shaft drives a gear disposed at a front end of the rotor shaft; an anvil for mounting a tool head to output power externally; a grip connected to or formed on the housing; an impact assembly disposed in the housing and used for providing an impact force to the anvil; and a transmission assembly disposed in the housing and used for transmitting the power outputted by the rotor shaft to the impact assembly, where the transmission assembly is disposed between the electric motor and the impact assembly. A front end of the rotor shaft includes an axial recessed portion, the gear includes an axial extension portion, and the axial extension portion mates with the axial recessed portion to fixedly mount the gear on the rotor shaft.

In some examples, the cooperation between the axial extension portion and the axial recessed portion includes that the axial extension portion is inserted into the axial recessed portion.

In some examples, the impact wrench further includes a front bearing disposed on the axial extension portion.

In some examples, the outer diameter of the front bearing is less than or equal to 15 mm.

In some examples, the diameter of the rotor shaft is greater than or equal to 7 mm.

In some examples, the cooperation between the axial extension portion and the axial recessed portion is that the axial extension portion and the axial recessed portion are mounted with an interference fit.

In some examples, a power tool includes a housing; an electric motor accommodated in the housing and including a stator assembly and a rotor assembly, where the rotor assembly includes a rotor shaft, and the rotor shaft drives a pinion disposed at a front end of the rotor shaft; a main shaft disposed in front of the rotor shaft and driven by the pinion to rotate, where a first opening is formed at a front end of the main shaft; and an anvil disposed in front of the main shaft, where a second opening for accommodating a tool head is formed at a front end of the anvil, the second opening includes a limiting portion for limiting the insertion depth of the tool head, and a rear end of the anvil is accommodated in the first opening and mates with the first opening so that the anvil is driven by the main shaft to rotate. The axial distance between the limiting portion and the frontmost end of the first opening is less than or equal to 5 mm.

In some examples, when a double-headed tool head is mounted in the anvil, the axial distance between a rear end of the double-headed tool head and the frontmost end of the first opening is less than or equal to 5 mm.

In some examples, when a single-headed tool head is mounted in the anvil, the axial distance between a rear end of the single-headed tool head and the frontmost end of the first opening is less than or equal to 5 mm.

In some examples, the power tool includes a chuck bushing, where the anvil includes an anvil bushing, and the axial positions of the chuck bushing and the anvil bushing at least partially

In some examples, the power tool includes a gear button and a battery pack, where the gear button is used for controlling a working gear of the power tool, and the gear button is disposed on a side of the battery pack.

In some examples, the inner diameter of the first opening is greater than or equal to 6 mm.

In some examples, the outer diameter of the first opening is greater than or equal to 1.5 times the inner diameter of the opening.

In some examples, the distance between the rearmost edge of the housing and the frontmost edge of the anvil is less than or equal to 95 mm.

In some examples, a power tool includes a housing; an electric motor accommodated in the housing and including a stator assembly and a rotor assembly, where the rotor assembly includes a rotor shaft, and the rotor shaft drives a pinion disposed at a front end of the rotor shaft; a main shaft disposed in front of the rotor shaft and driven by the pinion to rotate, where a first opening is formed at a front end of the main shaft; and an anvil disposed in front of the main shaft, where a second opening for accommodating a tool head is formed at a front end of the anvil, and a rear end of the anvil is accommodated in the first opening and mates with the first opening so that the anvil is driven by the main shaft to rotate. The outer diameter of the first opening is greater than or equal to 15 mm, and the distance between the rearmost edge of the housing and the frontmost edge of the anvil is less than or equal to 95 mm.

In some examples, the tool head is a single-headed tool head.

In some examples, the tool head is a double-headed tool head.

In some examples, the second opening includes a limiting portion for limiting the insertion depth of the tool head, and the axial distance between the limiting portion and the frontmost end of the first opening is less than or equal to 6 mm.

### BRIEF DESCRIPTION OF THE DRAWINGS

FIG. 1 is a side view of an impact wrench according to an example.

FIG. 2 is a sectional view of the impact wrench in FIG. 1.

FIG. 3 is a side view of a gear and a bearing of the impact wrench in FIG. 1.

FIG. 4 is an exploded view of a transmission assembly and an impact assembly of the impact wrench in FIG. 1.

FIG. 5 is a sectional view of an impact wrench in which a rotor shaft and a gear are integrally formed according to an example.

FIG. 6 is a perspective view of bearings, an electric motor, and the gear in FIG. 5.

FIG. 7 is a sectional view of an impact wrench in which a rotor shaft and a gear are separately provided according to an example.

FIG. 8 is a perspective view of the impact wrench in which the rotor shaft and the gear are separately provided in FIG. 7.

FIG. 9 is a partial sectional view of the impact wrench in FIG. 1.

FIG. 10 is a partial enlarged view illustrating that the axial positions of a front bearing and a stator assembly in FIG. 9 at least partially overlap.

FIG. 11 is a partial enlarged view illustrating that a rear cover and a main shaft in FIG. 9 have an overlapping portion in an axial direction.

FIG. 12 is a sectional view of a main shaft and an anvil in FIG. 1.

FIG. 13 is a sectional view of an impact structure in FIG. 1.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

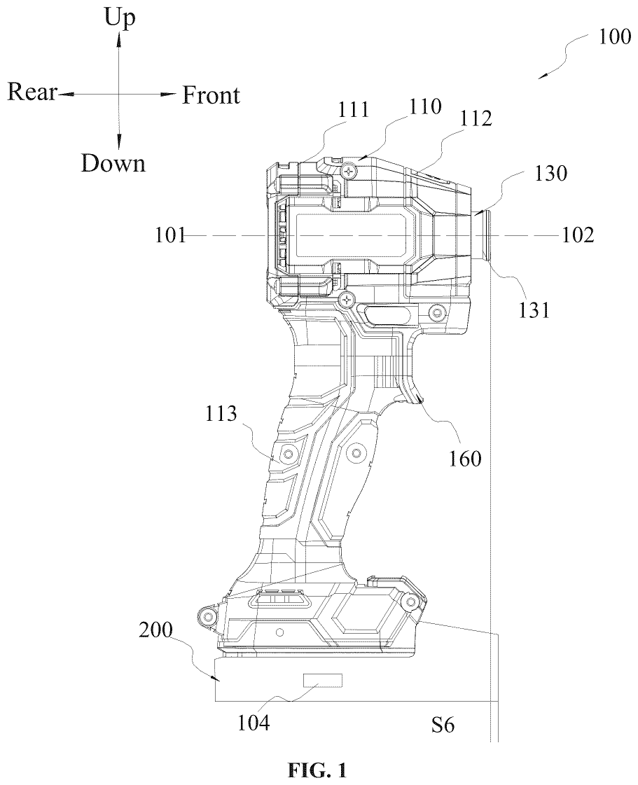

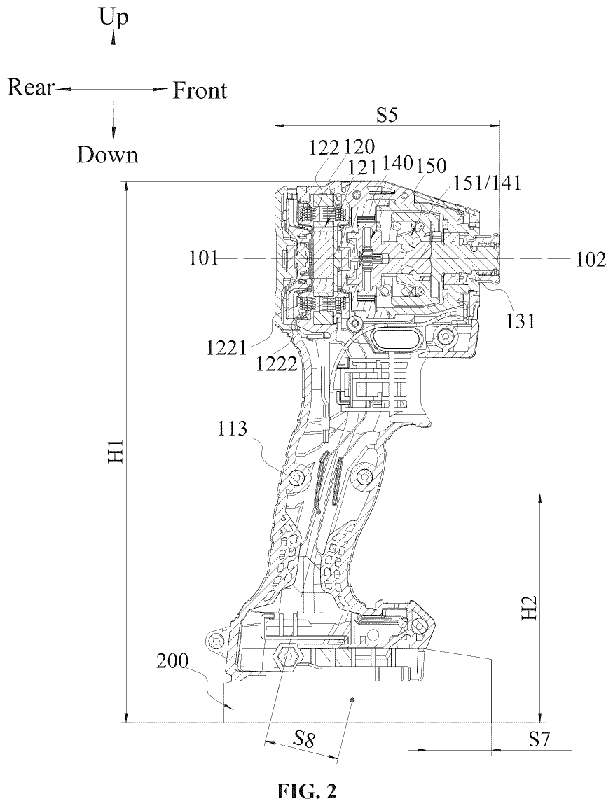

FIGS. 1 and 2 show a power tool in an example of the present application. In this example, the power tool is an impact wrench, specifically an impact wrench 100. It is to be understood that the impact wrench 100 is a rotary tool on which different work attachments may be mounted. In other alternative examples, the power tool may also be, for example, an electric drill, a drywall screwdriver, or an angle grinder. To facilitate the description of technical solutions, a front side, a rear side, an upper side, and a lower side are defined, as shown in FIG. 1. The front and rear direction is the axial direction of the impact wrench 100, and the up and down direction is the radial direction of the impact wrench 100.

FIG. 1 shows the impact wrench 100 in the example of the present application, where the impact wrench 100 includes a power supply. The power supply is used for supplying electrical energy to the impact wrench 100. In this example, the power supply includes a direct current power supply 200. For example, the direct current power supply 200 is a battery pack. Corresponding components in the impact wrench 100 are powered by the battery pack in conjunction with a corresponding power circuit. It is to be understood by those skilled in the art that the power supply is not limited to the battery pack, and the corresponding components in the machine may be powered through mains power or an alternating current power supply in conjunction with corresponding rectifier, filter, and voltage regulator circuits. In this example, the direct current power supply 200 is specifically configured to be the battery pack. A battery pack 200 is used below instead of the direct current power supply, which is not intended to limit the present application.

As shown in FIGS. 1 to 3, the impact wrench 100 includes a housing 110, an electric motor 120, an output assembly 130, a transmission assembly 140, and an impact assembly 150. As can be seen below, the preceding components may share some structures. Therefore, the present disclosure is not intended to confine the preceding components to being completely independent parts.

The electric motor 120 includes a rotor assembly 121 and a stator assembly 122. The rotor assembly 121 includes a rotor core 1211 and a rotor shaft 1212. The rotor shaft 1212 protrudes from the end surfaces of the rotor core 1211 in the front and rear direction. The rotor shaft 1212 rotates about a first axis 101. The stator assembly 122 includes stator windings 1221 and a stator core 1222, and the stator windings 1221 are wound onto the stator core 1222. In this example, the electric motor 120 is a brushless inner rotor motor. In other alternative examples, the electric motor 120 is a brushless outrunner. In the inner rotor motor, the stator core 1222 is disposed on the outer side of the rotor assembly 121. In the outrunner, the rotor assembly 121 is sleeved on the outer side of the stator core 1222. In this example, the brushless motor is configured to be a three-phase brushless motor. It is to be understood that the electric motor is not limited to the three-phase brushless motor and may be a direct current electric motor of another type. The above does not affect the substance of the present application.

In some examples, the width of the electric motor 120 is 52 mm. In some examples, the stack length of the rotor assembly 121 is 8.5 mm, and the maximum axial length of the rotor assembly 121 is 38.5 mm. In some examples, the stack length of the stator assembly 122 is 8 mm, and the maximum axial length of the stator assembly 122 is 20.8 mm.

The housing 110 includes a motor housing 111 for accommodating the electric motor 120 and an output housing 112 for accommodating at least part of the output assembly 130. The output housing 112 is connected to the front end of the motor housing 111. The housing 110 is further formed with or connected to a grip 113 for a user to operate. The grip 113 and the motor housing 111 form a T-shaped or L-shaped structure, facilitating the grip and operation of the user. The battery pack 200 is connected to an end of the grip 113. The battery pack 200 is detachably connected to the grip 113.

As shown in FIG. 1, the impact wrench 100 further includes a switch 160. The switch 160 is a trigger switch. The trigger switch is disposed on the grip 113 to be operated by the user to control the impact wrench 100 to be switched on or off.

The output assembly 130 includes an output portion 131 for connecting a tool head and outputting power externally to drive the tool head to rotate. A clamping assembly is disposed at the front end of the output portion 131 and may clamp the corresponding tool head such as a screwdriver bit, a drill bit, or a sleeve when different functions are implemented.

The output portion 131 is used for outputting power and rotates about an output axis 102. In this example, the first axis 101 coincides with the output axis 102. In other alternative examples, an angle of a certain degree exists between the output axis 102 and the first axis 101. In other alternative examples, the first axis 101 and the output axis 102 are parallel to each other but do not coincide with each other.

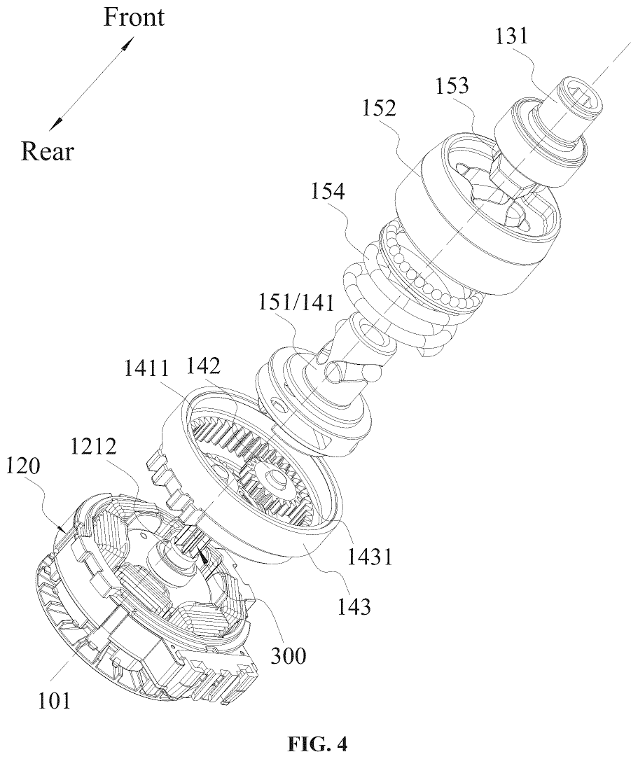

As shown in FIGS. 2 and 4, the impact assembly 150 is used for providing an impact force to the output portion 131. The impact assembly 150 includes a main shaft 151, an impact block 152 sleeved on the outer circumference of the main shaft 151, an anvil 153 disposed at the front end of the impact block 152, and an elastic element 154. The anvil 153 is connected to the output portion 131. The output portion 131 is formed at or connected to the front end of the anvil 153. It is to be understood that the anvil 153 and the output portion 131 may be integrally formed or separately formed as independent parts.

The impact block 152 is driven by the rotor shaft 1212 to rotate. The anvil 153 mates with the impact block 152 and is impacted by the impact block 152. The main shaft 151 connects the impact block 152 to the rotor shaft 1212. In some examples, the rotor shaft 1212 drives the main shaft 151, and the main shaft 151 drives the impact block 152 to rotate.

The output portion 131 extends out of the output housing 112. The impact block 152 is supported by the main shaft 151 to rotate integrally with the main shaft 151 and can slide back and forth relative to the main shaft 151 in the axial direction of the main shaft 151. In some examples, the axis of the main shaft 151 coincides with the axis of the rotor shaft 1212. Therefore, the impact block 152 slides back and forth relative to the main shaft 151 along the direction of the first axis 101 and rotates. In some examples, the axis of the main shaft 151 may be parallel to the axis of the rotor shaft 1212 but does not coincide with the axis of the rotor shaft 1212. Alternatively, the axis of the main shaft 151 and the axis of the rotor shaft 1212 may be set at a certain angle.

The elastic element 154 provides a force for the impact block 152 to approach the anvil 153. Optionally, the elastic element 154 may be a coil spring. In a working process of the impact wrench 100, the impact block 152 moves back and forth along the direction of the first axis 101 at a predetermined stroke relative to the main shaft 151 while rotating integrally with the main shaft 151.

When the impact wrench 100 works with no load, the impact assembly 150 performs no impact and implements a transmission function to transmit the rotation of the electric motor 120 to the output portion 131. When a load is applied to the impact wrench 100, the rotation of the output portion 131 is hindered. The output portion 131 may decrease in rotational speed or may completely stop rotating due to different magnitudes of the load. When the output portion 131 completely stops rotating, the anvil 153 also stops rotating and is completely disengaged from the impact block 152. The main shaft 151 drives the impact block 152 to rotate at a certain rotational speed, and the elastic element 154 springs back along the axial direction. The relative rotational speed between the impact block 152 and the anvil 153 is the rotational speed of the impact block 152. When the impact block 152 rotates to be in contact with the anvil 153, the impact block 152 applies an impact force to the anvil 153. Under the action of this impact force, the output portion 131 overcomes the load and continues rotating by a certain angle, and then the output portion 131 stops rotating again. The preceding process is repeated. Since the impact frequency is high enough, a relatively continuous impact force is applied to the output portion 131 so that the work attachment works continuously.

The transmission assembly 140 is configured to transmit the torque outputted by the rotor shaft 1212 to the output portion 131. In this example, the transmission assembly 140 is disposed between the electric motor 120 and the impact assembly 150 and used for transmitting power between the rotor shaft 1212 and the main shaft 151. In this example, the transmission assembly 140 performs deceleration by using planet gears. The working principle according to which the planet gears perform deceleration and the deceleration performed by the transmission assembly have been fully disclosed to those skilled in the art. Therefore, a detailed description is omitted here for clarity of description.

In some examples, as shown in FIG. 2, the overall height H1 of the impact wrench 100 may be 199.5 mm. In some examples, as shown in FIG. 2, the height H2 of the center of the impact wrench 100 may be 31 mm.

In some examples, the output power of the electric motor 120 is less than or equal to 630 W. Optionally, the output power of the electric motor 120 is 600 W. Optionally, the output power of the electric motor 120 is 580 W. Optionally, the output power of the electric motor 120 is 550 W. Optionally, the output power of the electric motor 120 is 400 W.

In some examples, the output torque of the impact wrench 100 is less than or equal to 150 N·m. Optionally, the output torque of the impact wrench 100 is 130 N·m. Optionally, the output torque of the impact wrench 100 is 110 N·m. Optionally, the output torque of the impact wrench 100 is 100 N·m. Optionally, the output torque of the impact wrench 100 is 80 N·m.

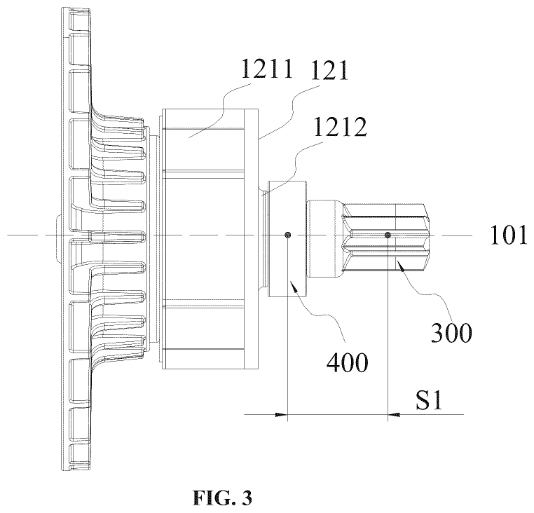

In some examples, as shown in FIG. 3, a gear 300 is disposed at the front end of the rotor shaft 1212, the rotor shaft 1212 drives the gear 300, and then the gear 300 drives the output portion 131. Specifically, the rotor shaft 1212 rotates to drive the gear 300 to rotate, the rotor shaft 1212 and the gear 300 rotate synchronously, the gear 300 drives the planet gears meshing with the gear 300 to rotate, and the planet gears drive the output portion 131. A bearing 400 is disposed behind the gear 300. The bearing 400 is sleeved on the rotor shaft 1212. The bearing 400 is used for supporting the rotor shaft 1212. The rotor shaft 1212 may be provided with a protruding portion for the bearing 400 to be sleeved on. Alternatively, the rotor shaft 1212 may not be provided with the protruding portion, and the bearing 400 may be directly sleeved on the rotor shaft 1212. Optionally, the inner diameter D1 of the bearing 400 is less than the diameter D2 of the gear 300. Optionally, the inner diameter D1 of the bearing 400 is less than or equal to 7 mm. Optionally, the inner diameter D1 of the bearing 400 is 6 mm. Optionally, the inner diameter D1 of the bearing 400 is 5.5 mm. Optionally, the inner diameter D1 of the bearing 400 is 4.8 mm. Optionally, the diameter D2 of the gear 300 is greater than or equal to 7 mm. Optionally, the diameter D2 of the gear 300 is 7.5 mm. Optionally, the diameter D2 of the gear 300 is 8 mm. Optionally, the diameter D2 of the gear 300 is 8.3 mm. Optionally, the diameter D2 of the gear 300 is 9 mm.

In some examples, since the bearing 400 is sleeved on the front end of the rotor shaft 1212, the outer diameter D3 of the bearing 400 is greater than the diameter D4 of the rotor shaft 1212. Optionally, the outer diameter D3 of the bearing 400 is greater than or equal to 8 mm and less than or equal to 16 mm. Optionally, the outer diameter D3 of the bearing 400 is 15 mm. Optionally, the outer diameter D3 of the bearing 400 is 14.5 mm. Optionally, the outer diameter D3 of the bearing 400 is 14 mm. The outer diameter D3 of the bearing 400 is 13.8 mm. Optionally, the diameter D4 of the rotor shaft 1212 is greater than or equal to 7 mm. Optionally, the diameter D4 of the rotor shaft 1212 is 7.5 mm. Optionally, the diameter D4 of the rotor shaft 1212 is 8 mm. Optionally, the diameter D4 of the rotor shaft 1212 is 8.3 mm.

Optionally, the distance S1 between the bearing 400 and the gear 300 is less than or equal to 12 mm. The distance S1 between the bearing 400 and the gear 300 is specifically the distance between the center point of the bearing 400 and the center point of the gear 300.

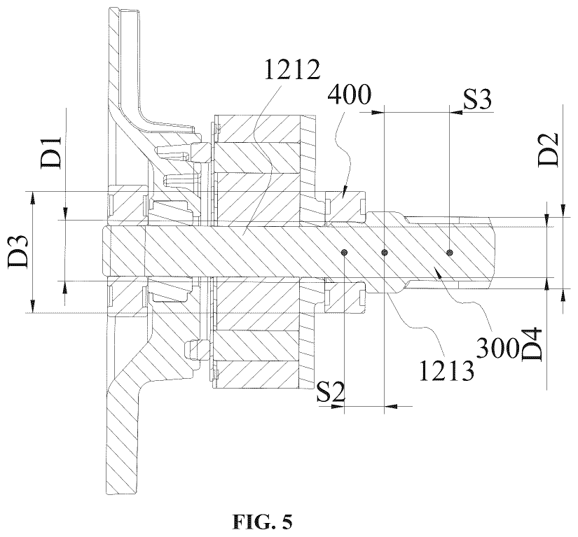

In some examples, the rotor shaft 1212 and the gear 300 are integrally formed. Specifically, the gear 300 is directly formed at the front end of the rotor shaft 1212. As shown in FIG. 5, the rotor shaft 1212 further includes a protruding portion 1213. The gear 300 is located at the front end of the rotor shaft 1212, specifically at the front end of the protruding portion 1213, and the bearing 400 is located behind the gear 300, specifically at the rear end of the protruding portion 1213. When the rotor shaft 1212 is provided with the protruding portion for the bearing 400 to be sleeved on, the width of the protruding portion on which the bearing 400 is sleeved is less than the width of the protruding portion 1213 so that the bearing 400 is limited at the rear end of the protruding portion 1213. The bearing 400 is a front bearing, and a front bearing 400 is used below instead of the bearing 400 for a specific description. The distance S2 between the front bearing 400 and the protruding portion 1213 and the distance S3 between the protruding portion 1213 and the gear 300 are both less than 8.5 mm. The distance S2 between the front bearing 400 and the protruding portion 1213 is specifically the distance between the center point of the front bearing 400 and the center point of the protruding portion 1213, and the distance S3 between the protruding portion 1213 and the gear 300 is specifically the distance between the center point of the protruding portion 1213 and the center point of the gear 300.

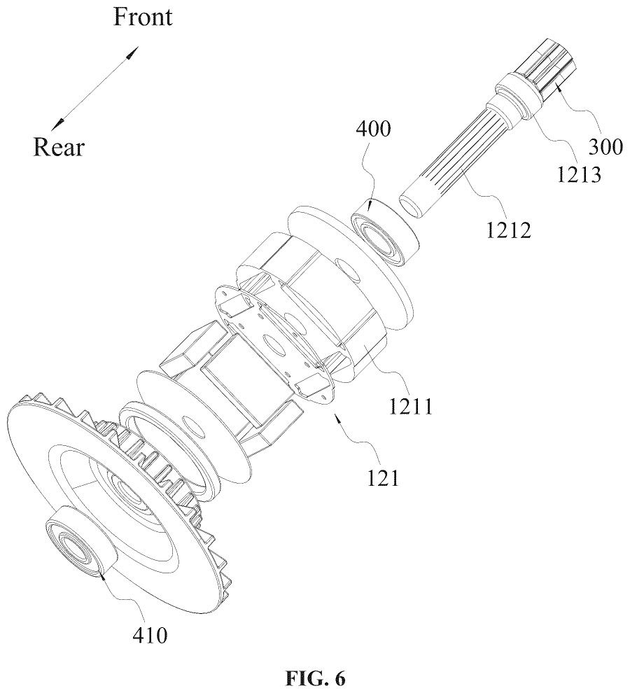

Optionally, as shown in FIG. 5, the inner diameter D1 of the front bearing 400 is less than the outer diameter of the protruding portion 1213. Therefore, after sleeved on the rotor shaft 1212, the front bearing 400 can be limited by the protruding portion 1213 and cannot move forward any further. The diameter D2 of the gear 300 is greater than the diameter of the rotor shaft 1212, and the diameter D2 of the gear 300 is less than the outer diameter of the protruding portion 1213. The diameter D2 of the gear 300 is less than the outer diameter of the protruding portion 1213, and the rotor shaft 1212 and the gear 300 are integrally formed. Therefore, the front bearing 400, the rotor assembly 121, and other related structures cannot be assembled to the rotor shaft 1212 from the front to the rear as in the existing art. The front bearing 400 and the rotor assembly 121 are assembled to the rotor shaft 1212 as shown in FIG. 6. According to the structure shown in FIG. 6, the front bearing 400 and the rotor assembly 121 are mounted one by one to the rotor shaft 1212 from the rear to the front. The assembly process includes: first, sleeving the front bearing 400 on the rotor shaft 1212 from the rear end of the rotor shaft 1212 and moving the front bearing 400 forward until the front bearing 400 is limited by the protruding portion 1213 and cannot move forward any further. Next, the rotor assembly 121 and the fan are sleeved on the rotor shaft 1212 in sequence from the rear to the front. Optionally, the rotor assembly 121 may be pre-mounted and sleeved on the rotor shaft 1212 as a whole. Optionally, multiple structures such as a front end plate, the rotor core 1211, magnetic tiles, gaskets, and rubber pads included in the rotor assembly 121 are sleeved on the rotor shaft 1212 in sequence from the rear to the front and combined on the rotor shaft 1212 to form a whole rotor assembly 121. Finally, a rear bearing 410 is sleeved on the rotor shaft 1212 to support the rotor shaft 1212. The front bearing 400 and the rear bearing 410 jointly limit and fix the rotor assembly 121 on the rotor shaft 1212 in the axial direction.

In some examples, the outer diameter of the front bearing 400 is less than or equal to 1.5 times the outer diameter of the rear bearing 410. Optionally, the outer diameter of the front bearing 400 is equal to the outer diameter of the rear bearing 410 so that the front bearing 400 occupies a smaller space in the radial direction of the impact wrench 100, a larger space in the radial direction of the impact wrench 100 is provided, and multiple structures such as the front bearing 400, the stator assembly 122, a rear cover 143, and a main shaft 141 partially overlap in the axial direction.

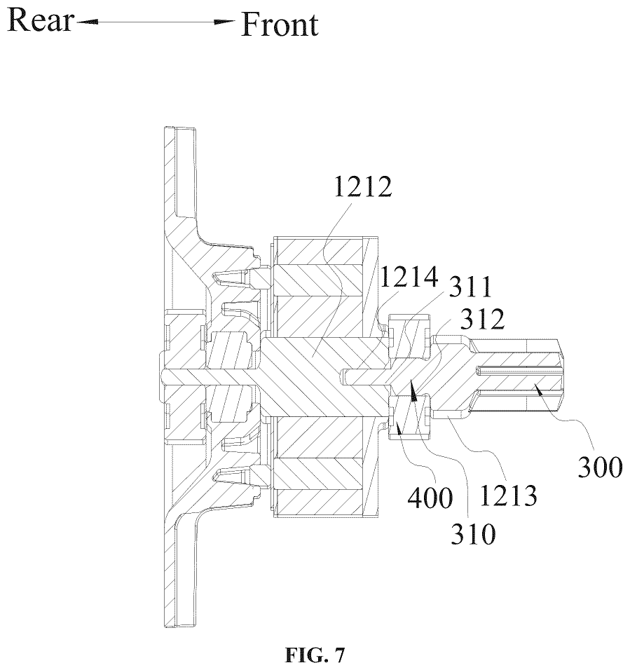

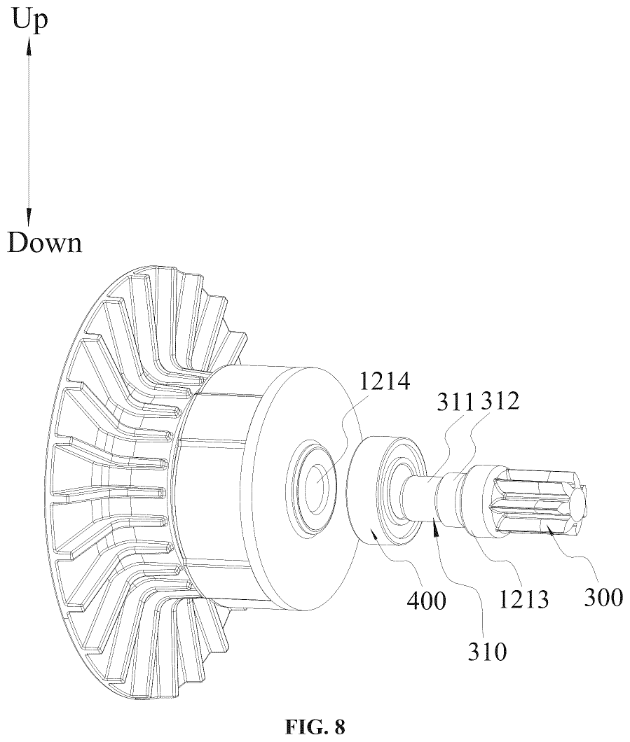

In some examples, the rotor shaft 1212 and the gear 300 are separately provided. As shown in FIGS. 7 and 8, the rotor shaft 1212 includes an axial recessed portion 1214, the gear 300 includes an axial extension portion 310, and the axial extension portion 310 may mate with the axial recessed portion 1214 to fixedly mount the gear 300 on the rotor shaft 1212. Specifically, the cooperation between the axial extension portion 310 and the axial recessed portion 1214 is that the axial extension portion 310 is inserted into the axial recessed portion 1214. The front bearing 400 is disposed on the axial extension portion 310. The axial extension portion 310 includes a first extension portion 311 and a second extension portion 312. The first extension portion 311 is inserted into the axial recessed portion 1214, and the front bearing 400 is disposed on the second extension portion 312. The diameter of the second extension portion 312 matches the inner diameter of the front bearing 400. Optionally, the diameter of the first extension portion 311 is different from the diameter of the second extension portion 312. Specifically, the diameter of the first extension portion 311 is less than the diameter of the second extension portion 312 so that the front bearing 400 can be sleeved on the second extension portion 312 after passing through the first extension portion 311. Optionally, the diameter of the first extension portion 311 and the diameter of the second extension portion 312 may also be the same. In this case, the diameter of the first extension portion 311 and the diameter of the second extension portion 312 both match the inner diameter of the front bearing 400. As shown in FIGS. 7 and 8, in this case, the gear 300 includes the protruding portion 1213 for limiting the front bearing 400.

Optionally, the cooperation between the axial extension portion 310 and the axial recessed portion 1214 may be that the axial extension portion 310 and the axial recessed portion 1214 are mounted with an interference fit so that a gap between the axial extension portion 310 and the axial recessed portion 1214 can be avoided, and the axial extension portion 310 can be better fixedly mounted in the axial recessed portion 1214. In this manner, during the operation of the impact wrench 100, the axial extension portion 310 and the axial recessed portion 1214 do not slide relative to each other.

The rotor shaft 1212 and the gear 300 are integrally formed, that is, the rotor shaft 1212 is configured to be a gear shaft, so that the rotor shaft 1212 can transmit torque. Moreover, when the rotor shaft 1212 and the gear 300 are integrally formed or the gear 300 is inserted into the rotor shaft 1212, since the front bearing 400 is sleeved on the rotor shaft 1212 from the rear to the front, the diameter of the part where the rotor shaft 1212 mates with the front bearing 400 is smaller, that is, the inner diameter of the front bearing 400 is smaller. In addition, the dimension ratio of the front bearing 400 is fixed. Therefore, the axial length and radial length of the front bearing 400 are both smaller so that the overall length and radial dimension of the impact wrench 100 are both reduced.

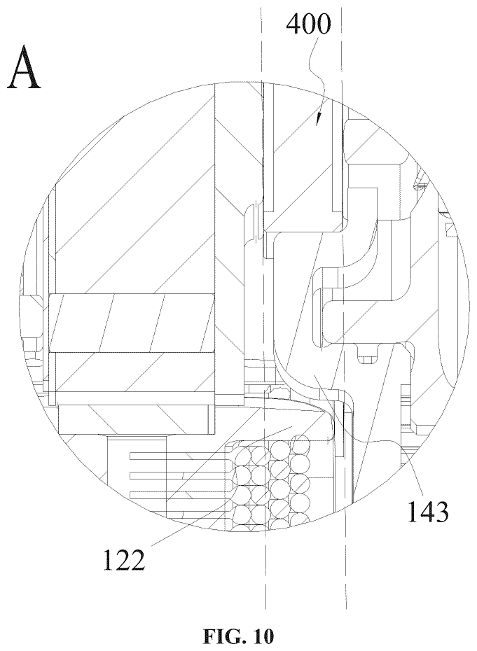

In some examples, the axial positions of the front bearing 400 and the stator assembly 122 at least partially overlap. Specifically, as shown in FIG. 10, the axial positions of the front bearing 400 and the stator assembly 122 overlap so that the length of the impact wrench 100 in the axial direction is further shortened.

In some examples, as shown in FIGS. 2 and 4, the transmission assembly 140 includes the main shaft 141 disposed in the extension direction of the rotor shaft 1212, specifically, in the extension direction of the front end of the rotor shaft 1212. The main shaft 141 included in the transmission assembly 140 and the main shaft 151 included in the impact assembly 150 are of the same structure. For the convenience of description, the main shaft 141 is used to indicate the structure hereinafter.

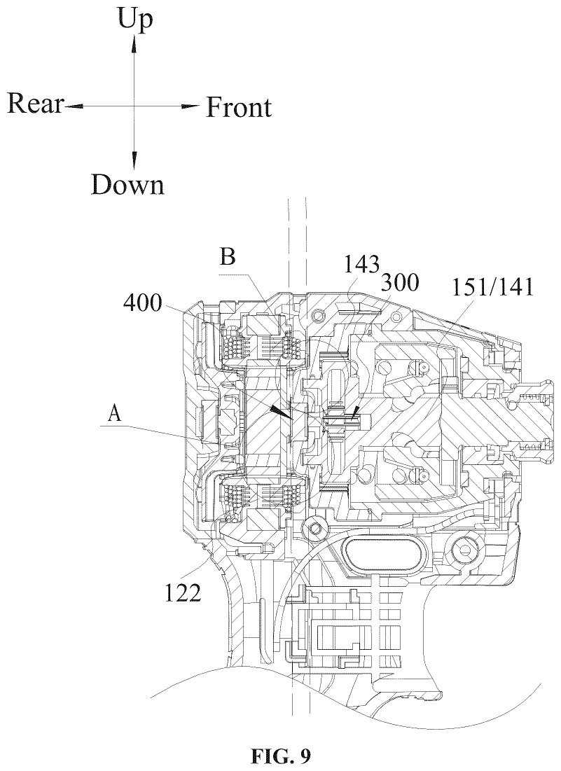

The main shaft 141 includes multiple planetary shafts 1411, and the planetary shafts 1411 may be parallel to the extension direction of the rotor shaft 1212. The transmission assembly 140 includes multiple planet gears 142, and the number of the multiple planetary shafts 1411 is the same as the number of the multiple planet gears 142. The multiple planet gears 142 are disposed around the multiple planetary shafts 1411, respectively. Specifically, each of the multiple planet gear 142 is sleeved on a respective planetary shaft 1411. As shown in FIG. 9, a recessed portion mating with the gear 300 is disposed on the rear side of the main shaft 141. The gear 300 extends into the recessed portion of the main shaft 141 and drives the multiple planet gears 142. Specifically, the gear 300 meshes with the multiple planet gears 142, the gear 300 is located in the middle among the multiple planet gears 142, and the gear 300 rotates to drive the multiple planet gears 142 to rotate.

The transmission assembly 140 further includes the rear cover 143 surrounding at least part of the main shaft 141 from the rear to the front. The rear cover 143 is the rear cover 143 of a gearbox, and the gearbox is formed by the gear 300 and the multiple planet gears 142. In some examples, the rear cover 143 is formed with an inner ring gear 1431, that is, the inner ring gear 1431 is directly formed inside the rear cover 143, and the rear cover 143 and the inner ring gear 1431 are integrally formed, without the need to separately set an inner ring gear as in the existing art, thereby reducing both the overall length and radial dimension of the impact wrench 100. The inner ring gear 1431 meshes with the multiple planet gears 142, and the multiple planet gears 142 rotate in the inner ring gear 1431.

In some examples, the impact wrench 100 has no bearing for the main shaft 141, the main shaft 141 is in direct contact with the rear cover 143, and the main shaft 141 is limited by the rear cover 143. Therefore, when the multiple planet gears 142 rotate in the inner ring gear 1431, the rear cover 143 is in sliding contact with the main shaft 141. Specifically, the main shaft 141 extends into the rear cover 143; and when the multiple planet gears 142 rotate, the main shaft 141 rotates relative to the rear cover 143, that is, the main shaft 141 slides and rotates relative to the rear cover 143 within the rear cover 143. The impact wrench 100 has no bearing for the main shaft 141 so that the length of the impact wrench 100 in the axial direction is further shortened.

The main shaft 141 continuously rubs against the rear cover 143 when the multiple planet gears 142 rotate in the inner ring gear 1431. Therefore, the material hardness of a contact region between the rear cover 143 and the main shaft 141 is greater than or equal to 20 HRC, thereby improving the wear resistance of the rear cover 143. Optionally, the material hardness of the contact region between the rear cover 143 and the main shaft 141 is 25 HRC. Optionally, the material hardness of the contact region between the rear cover 143 and the main shaft 141 is 30 HRC. Optionally, the material hardness of the contact region between the rear cover 143 and the main shaft 141 is 37 HRC. Optionally, the material hardness of the contact region between the rear cover 143 and the main shaft 141 is 42 HRC. Optionally, the material hardness of the contact region between the rear cover 143 and the main shaft 141 is 50 HRC.

In some examples, the rear cover 143 is made through powder metallurgy. In some examples, the contact region between the rear cover 143 and the main shaft 141 is hardened by carburizing so that the surface layer of the contact region between the rear cover 143 and the main shaft 141 has high hardness and wear resistance, while the central part of the contact region still maintains the toughness and plasticity of low-carbon steel. In addition, the contact region between the rear cover 143 and the main shaft 141 may also be made in any other method that can achieve high toughness in the central part and high surface hardness, which is not limited to the present application.

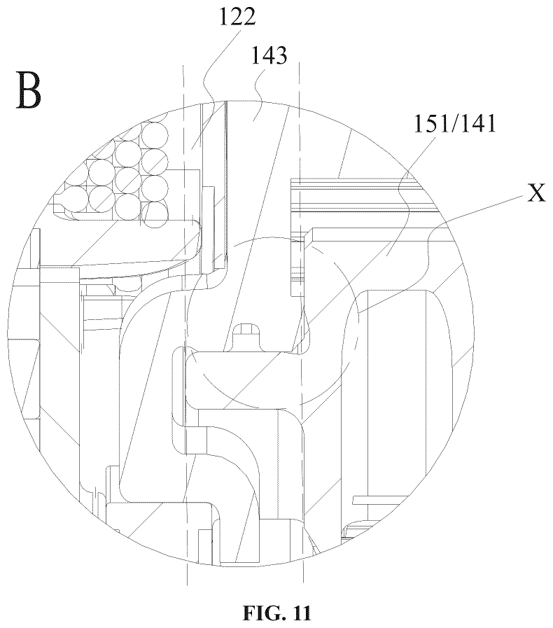

In some examples, as shown in FIG. 11, since the main shaft 141 has no bearing and the rear cover 143 is formed with the inner ring gear 1431, the rear cover 143 and the main shaft 141 have an overlapping portion in the axial direction. The overlapping portion of the rear cover 143 and the main shaft 141 in the axial direction includes a contact region X between the rear cover 143 and the main shaft 141. As can be seen from FIG. 11, the contact region between the rear cover 143 and the main shaft 141 includes both an axial contact region and a radial contact region. In some examples, the axial overlap length of the contact region between the rear cover 143 and the main shaft 141 is greater than or equal to 1.5 mm, that is, the sliding fit distance between the rear cover 143 and the main shaft 141 is greater than or equal to 1.5 mm. In some examples, as shown in FIG. 11, the axial positions of the main shaft 141 and the stator assembly 122 at least partially overlap. In the existing art, the rear cover and the main shaft do not overlap in the axial direction, and the stator assembly and the main shaft do not overlap in the axial direction so that the overall length of the impact wrench 100 is longer. In the present application, the rear cover 143 and the main shaft 141 partially overlap in the axial direction, and the main shaft 141 and the stator assembly 122 partially overlap in the axial direction so that the overall length of the impact wrench 100 is shortened.

In some examples, the impact wrench 100 includes a support portion disposed on the rear part of the main shaft 141 and used for supporting the main shaft 141. In this example, the support portion is the rear cover 143, and the rear cover 143 supports the main shaft 141. In other examples, in the case where the power tool includes a bearing for the main shaft, the support portion is the bearing for the main shaft, and the main shaft 141 is supported by the bearing for the main shaft.

Optionally, the axial positions of the support portion, the stator assembly 122, and the front bearing 400 at least partially overlap. Specifically, as shown in FIG. 10, the axial positions of the rear cover 143, the stator assembly 122, and the front bearing 400 at least partially overlap. Optionally, the axial positions of the main shaft 141 and the front bearing 400 partially overlap. Optionally, as shown in FIG. 9, the axial positions of the front bearing 400, the stator assembly 122, the rear cover 143, and the main shaft 141 at least partially overlap. The axial positions of the front bearing 400, the stator assembly 122, the rear cover 143, and the main shaft 141 partially overlap so that a partial region in the axial direction of the impact wrench 100 can be occupied by the stator assembly 122, the rear cover 143, and the main shaft 141 at the same time, thereby making the axial length of the impact wrench 100 shorter.

In some examples, the anvil 153 and the output portion 131 are integrally formed, and the output portion 131 is the anvil 153. In the present application, the anvil 153 is used to represent the output portion 131 for a specific description. The anvil 153 is used for mounting a tool head to output power externally.

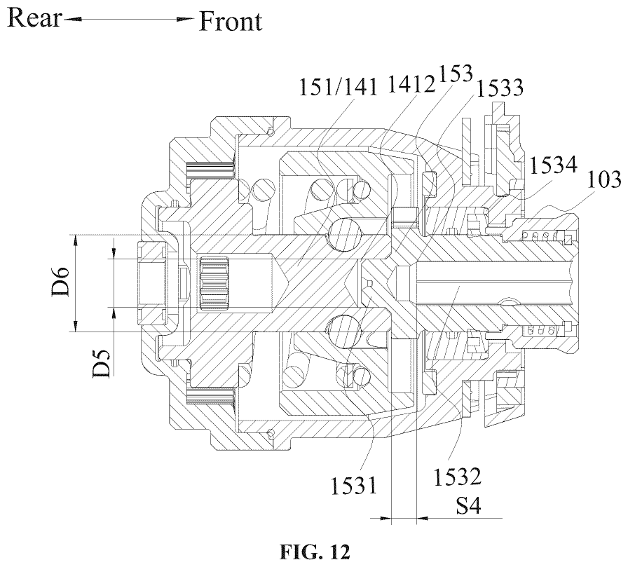

In some examples, a first opening 1412 is formed at the front end of the main shaft 141, the first opening 1412 is used for accommodating the rear end of the anvil 153, and the first opening 1412 mates with the rear end of the anvil 153 so that the anvil 153 is driven to rotate. As shown in FIG. 12, an anvil protruding portion 1531 is formed at the rear end of the anvil 153, and the anvil protruding portion 1531 mates with the first opening 1412. Specifically, the anvil protruding portion 1531 is inserted into the first opening 1412. Optionally, the anvil protruding portion 1531 and the first opening 1412 may be mounted with an interference fit so that the anvil protruding portion 1531 can be better fixedly mounted in the first opening 1412. In this manner, during the operation of the impact wrench 100, the first opening 1412 can always drive the anvil protruding portion 1531 to rotate, that is, the main shaft 141 can always drive the anvil 153 to rotate, and the anvil 153 does not slide relative to the main shaft 141.

In some examples, the inner diameter D5 of the first opening 1412 is greater than or equal to 6 mm. Optionally, the inner diameter D5 of the first opening 1412 is 6.5 mm. Optionally, the inner diameter D5 of the first opening 1412 is 7 mm. Optionally, the inner diameter D5 of the first opening 1412 is 7.3 mm. In this manner, the anvil protruding portion 1531 can be stably and fixedly mounted in the first opening 1412. In some examples, the outer diameter D6 of the first opening 1412 is greater than or equal to 1.5 times the inner diameter D5 of the opening. For example, when the inner diameter D5 of the first opening 1412 is 6 mm, the outer diameter D6 of the first opening 1412 is greater than or equal to 9 mm. For example, when the inner diameter D5 of the first opening 1412 is 7 mm, the outer diameter D6 of the first opening 1412 is greater than or equal to 10.5 mm. For example, when the inner diameter D5 of the first opening 1412 is 9 mm, the outer diameter D6 of the first opening 1412 is greater than or equal to 13.5 mm.

By providing the first opening 1412 on the main shaft 141, a portion of the anvil 153 can be inserted into the main shaft 141. That is, in the axial direction of the impact wrench 100, the main shaft 141 and the anvil 153 partially overlap so that when the length of the anvil 153 is fixed, the overall length of the impact wrench 100 is shortened.

In some examples, a second opening 1532 for accommodating a tool head is formed at the front end of the anvil 153, the second opening 1532 is used for accommodating and mounting the tool head, and the second opening 1532 includes a limiting portion 1533 for limiting the insertion depth of the tool head. Optionally, the second opening 1532 is used for mounting a double-headed tool head. Optionally, the second opening 1532 is used for mounting a single-headed tool head.

In some examples, as shown in FIG. 12, the axial distance S4 between the limiting portion 1533 and the frontmost end of the first opening 1412 is less than or equal to 5 mm. Optionally, the axial distance S4 between the limiting portion 1533 and the frontmost end of the first opening 1412 is 4.5 mm. Optionally, the axial distance S4 between the limiting portion 1533 and the frontmost end of the first opening 1412 is 4.2 mm. Optionally, the axial distance S4 between the limiting portion 1533 and the frontmost end of the first opening 1412 is 3.5 mm.

In some examples, when a double-headed tool head is mounted in the anvil 153, the axial distance between the rear end of the double-headed tool head and the frontmost end of the first opening 1412 is less than or equal to 5 mm. The rear end of the double-headed tool head refers to the rearmost end of the double-headed tool head inserted into the second opening 1532, and the axial distance between the rear end of the double-headed tool head and the frontmost end of the first opening 1412 is the minimum distance between the double-headed tool head and the first opening 1412.

In some examples, when a single-headed tool head is mounted in the anvil 153, the axial distance between the rear end of the single-headed tool head and the frontmost end of the first opening 1412 is less than or equal to 5 mm. The rear end of the single-headed tool head refers to the rearmost end of the single-headed tool head inserted into the second opening 1532, and the axial distance between the rear end of the single-headed tool head and the frontmost end of the first opening 1412 is the minimum distance between the double-headed tool head and the first opening 1412.

In some examples, the anvil 153 includes an anvil bushing 1534, and the impact wrench 100 includes a chuck bushing 103. As shown in FIG. 12, the anvil bushing 1534 and the chuck bushing 103 at least partially overlap in the axial direction, thereby shortening the length occupied by the anvil bushing 1534 and the chuck bushing 103 in the axial direction without affecting the anvil 153 clamping the tool head. In this manner, the overall length of the impact wrench 100 is shortened.

In some examples, as shown in FIG. 2, the distance S5 between the rearmost edge of the housing 110 and the frontmost edge of the anvil 153 is less than or equal to 95 mm, and the overall length of the impact wrench 100 is relatively small. Optionally, the distance S5 between the rearmost edge of the housing 110 and the frontmost edge of the anvil 153 is 92 mm. Optionally, the distance S5 between the rearmost edge of the housing 110 and the frontmost edge of the anvil 153 is 90 mm. Optionally, the distance S5 between the rearmost edge of the housing 110 and the frontmost edge of the anvil 153 is 89.5 mm. Optionally, the distance S5 between the rearmost edge of the housing 110 and the frontmost edge of the anvil 153 is 84 mm.

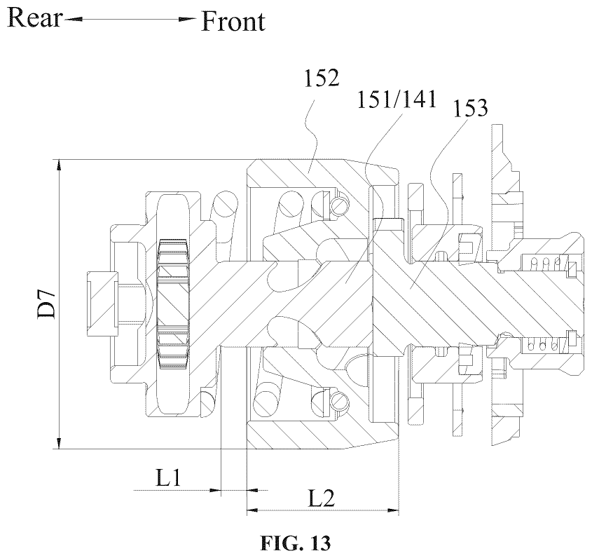

In some examples, as shown in FIG. 13, the ratio of the axial movement distance L1 of the impact block 152 to the diameter D7 of the impact block 152 is less than or equal to 0.3. Optionally, the ratio of the axial movement distance L1 of the impact block 152 to the diameter D7 of the impact block 152 is 0.25. The ratio of the axial movement distance L1 of the impact block 152 to the diameter D7 of the impact block 152 is 0.2. In some examples, the ratio of the distance S5 between the rearmost edge of the housing 110 and the frontmost edge of the anvil 153 to the diameter D7 of the impact block 152 is less than or equal to 2.5. Optionally, the ratio of the distance S5 between the rearmost edge of the housing 110 and the frontmost edge of the anvil 153 to the diameter D7 of the impact block 152 is 2.3. Optionally, the ratio of the distance S5 between the rearmost edge of the housing 110 and the frontmost edge of the anvil 153 to the diameter D7 of the impact block 152 is 2.0. Optionally, the ratio of the distance S5 between the rearmost edge of the housing 110 and the frontmost edge of the anvil 153 to the diameter D7 of the impact block 152 is 1.8. In some examples, the ratio of the distance S5 between the rearmost edge of the housing 110 and the frontmost edge of the anvil 153 to the front-to-rear length L2 of the impact block 152 is less than or equal to 4.7. Optionally, the ratio of the distance S5 between the rearmost edge of the housing 110 and the frontmost edge of the anvil 153 to the front-to-rear length L2 of the impact block 152 is 4.5. Optionally, the ratio of the distance S5 between the rearmost edge of the housing 110 and the frontmost edge of the anvil 153 to the front-to-rear length L2 of the impact block 152 is 4.1.

In the case where the axial movement distance L1 of the impact block 152 can satisfy the complete disengagement of the impact block 152, the axial movement distance L1 of the impact block 152 is reduced, the diameter D7 of the impact block 152 is increased, and the front-to-rear length L2 of the impact block 152 is reduced. Therefore, in the case where the axial length of the impact wrench 100 is relatively small, the output capacity of the impact wrench 100 is improved, thereby improving the working efficiency of the user.

In some examples, the impact wrench 100 includes a gear button 104 for controlling the working gear of the impact wrench 100. Since the overall length of the impact wrench 100 is shortened in the preceding multiple methods, to prevent the battery pack 200 from being in contact with or colliding with the working surface when the impact wrench 100 is working, as shown in FIGS. 1 and 2, the battery pack 200 is moved backward relative to the grip 113. Moreover, the gear button 104 is disposed on a side of the battery pack 200, thereby avoiding the following problem: the gear button 104 disposed in front of the battery pack 200 occupies the axial length of the impact wrench 100. In some examples, if the impact wrench 100 is equipped with a 2-inch screwdriver bit, when the screwdriver bit abuts against the surface of a workpiece, the distance between the frontmost end of the battery pack 200 and the surface of the workpiece is 29 mm.

In some examples, the distance S6 between the frontmost end of the battery pack 200 and the frontmost edge of the anvil 153 is 3 mm. Specifically, the battery pack 200 protrudes 3 mm relative to the frontmost edge of the anvil 153. In some examples, the distance S7 between a front end of the battery pack 200 and a front end of a standing portion of the impact wrench 100 is 30 mm. In some examples, the distance S8 between the center of gravity of the battery pack 200 and the extension line of the grip 113 of the impact wrench 100 is 37 mm.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. An impact wrench, comprising:
a housing;
an electric motor accommodated in the housing and comprising a stator assembly and a rotor assembly, the rotor assembly comprising a rotor shaft and a drive gear, driven by the rotor shaft, disposed at a front end of the rotor shaft;
an anvil for mounting a tool head to output power externally;
a grip connected to or formed on the housing;
an impact assembly disposed in the housing and used for providing an impact force to the anvil; and
a transmission assembly, disposed in the housing between the electric motor and the impact assembly, configured for transmitting power outputted by the rotor shaft to the impact assembly and comprising:
a main shaft, disposed in an extension direction of the rotor shaft, comprising a plurality of planetary shafts and a plurality of planet gears, driven by the drive gear, disposed around the plurality of planetary shafts, respectively; and
a rear cover, surrounding at least part of the main shaft from rear to front, formed with an inner ring gear that meshes with the plurality of planet gears;
wherein, when the plurality of planet gears rotate in the inner ring gear, the rear cover is in sliding contact with the main shaft.

2. The impact wrench of claim 1, wherein the rear cover and the inner ring gear are integrally formed.

3. The impact wrench of claim 1, wherein an axial overlap length of a contact region between the rear cover and the main shaft is greater than or equal to 1.5 mm.

4. The impact wrench of claim 1, wherein an outer diameter of the gear is greater than a diameter of the rotor shaft.

5. The impact wrench of claim 1, wherein the electric motor is an inner rotor motor.

6. The impact wrench of claim 1, further comprising a front bearing, wherein axial positions of the front bearing, the stator assembly, the rear cover, and the main shaft at least partially overlap.

7. The impact wrench of claim 1, wherein the impact wrench has no bearing for the main shaft.

8. The impact wrench of claim 1, wherein material hardness of a contact region of the rear cover is greater than or equal to 20 HRC.

9. The impact wrench of claim 1, wherein the rear cover is made through powder metallurgy.

10. The impact wrench of claim 1, wherein a contact region between the rear cover and the main shaft is carburized.

11. The impact wrench of claim 1, wherein the impact assembly comprises an impact block driven by the electric motor, the impact block is configured to reciprocate along an axial direction and impact the anvil along a rotational direction, a ratio of an axial movement distance of the impact block to a diameter of the impact block is less than or equal to 0.3, and a distance between a rearmost edge of the housing and a frontmost edge of the anvil is less than or equal to 95 mm.

12. The impact wrench of claim 1, wherein the impact assembly comprises an impact block driven by the electric motor, a ratio of a distance between a rearmost edge of the housing and a frontmost edge of the anvil to a diameter of the impact block is less than or equal to 2.5, and the distance between the rearmost edge of the housing and the frontmost edge of the anvil is less than or equal to 95 mm.

13. The impact wrench of claim 1, wherein the impact assembly comprises an impact block driven by the electric motor, a ratio of a distance between a rearmost edge of the housing and a frontmost edge of the anvil to a front-to-rear length of the impact block is less than or equal to 4.7, and the distance between the rearmost edge of the housing and the frontmost edge of the anvil is less than or equal to 95 mm.

14. The impact wrench of claim 1, comprising a chuck bushing, wherein the anvil comprises an anvil bushing, and axial positions of the chuck bushing and the anvil bushing at least partially

15. The impact wrench of claim 1, comprising a gear button and a battery pack, wherein the gear button is used for controlling a working gear of the impact wrench, and the gear button is disposed on a side of the battery pack.

16. A power tool, comprising:
a housing;
an electric motor accommodated in the housing and comprising a stator assembly and a rotor assembly, the rotor assembly comprising a rotor shaft and a drive gear, driven by the rotor shaft, disposed at a front end of the rotor shaft; and
a transmission assembly comprising:
a main shaft, disposed in an extension direction of the rotor shaft, comprising a plurality of planetary shafts and a plurality of planet gears, driven by the drive gear, disposed around the plurality of planetary shafts; and
a rear cover, surrounding at least part of the main shaft from rear to front, formed with an inner ring gear that meshes with the plurality of planet gears;
wherein, when the plurality of planet gears rotate in the inner ring gear, the rear cover is in sliding contact with the main shaft, and material hardness of a contact region of the rear cover is greater than or equal to 20 HRC.

17. A power tool, comprising:
a housing;
an electric motor accommodated in the housing and comprising a stator assembly and a rotor assembly, the stator assembly comprises stator windings and a stator core, the stator windings are wound onto the stator core, the stator core is disposed on an outer circumference of the rotor assembly, the rotor assembly comprises a rotor core and a rotor shaft protruding from end surfaces of the rotor core in a front and rear direction, and the rotor shaft is supported by a front bearing and a rear bearing and drives a drive gear disposed at a front end of the rotor shaft; and
a transmission assembly comprising:
a main shaft, disposed in an extension direction of the rotor shaft, comprising a plurality of planetary shafts and a plurality of planet gears, driven by the drive gear, disposed around the plurality of planetary shafts, respectively; and
a support portion disposed on a rear part of the main shaft and used for supporting the main shaft;
wherein axial positions of the support portion, the stator assembly, and the front bearing at least partially overlap, and an outer diameter of the front bearing is greater than or equal to 8 mm and less than or equal to 16 mm.

18. The power tool of claim 17, wherein the support portion is a rear cover of a gearbox, the rear cover of the gearbox is formed with an inner ring gear, and the inner ring gear meshes with the plurality of planet gears.

19. The power tool of claim 18, wherein, when the plurality of planet gears rotate in the inner ring gear, the rear cover of the gearbox is in sliding contact with the main shaft.

20. The power tool of claim 17, wherein the outer diameter of the front bearing is less than or equal to 1.5 times an outer diameter of the rear bearing.
